(19) United States
(12) Patent Application Publication
(10) Pub. No.: US 2015/0161595 A1
(43) Pub. Date: Jun. 11, 2015

(54) DIGITAL PAYMENT CARD PRESENTATION SYSTEMS, METHODS, AND APPARATUSES

(71) Applicant: RED GIANT, INC., PALO ALTO, CA (US)

(72) Inventor: Robert Kern Sears, Palo Alto, CA (US)

(21) Appl. No.: 14/562,500

(22) Filed: Dec. 5, 2014

Related U.S. Application Data
(60) Provisional application No. 61/912,762, filed on Dec. 6, 2013.

(51) Int. Cl. G06Q 20/34; G06Q 20/32; G06Q 20/40

(52) U.S. Cl. CPC G06Q 20/357; G06Q 20/40145; G06Q 20/3224; G06Q 20/409

(57) ABSTRACT

Disclosed are systems, methods, and apparatuses to securely present payment card information using a computing device such as a mobile phone. The digital payment card presentation may be controlled or influenced by context including geolocation, time, proximity to another device, or input from designated third parties. Specific examples of techniques used to maintain security and usability are disclosed.

### CROSS-REFERENCE TO RELATED APPLICATION(S)

This application claims priority to U.S. provisional application No. 61/912,762, filed Dec. 6, 2013, which application is incorporated herein by reference, in its entirety, for any purpose.

The entire disclosure of the prior application, from which a copy of the oath or declaration is supplied, is considered to be part of the disclosure of the instant application.

### BACKGROUND

Traditional payment cards are plastic or other physical material created with data-bearing elements such as magnetic stripes or embedded circuitry. They typically bear also a presentation of the relevant card number (the Primary Account Number, or PAN), expiration date (“expiry”), and a secondary card security code. Together, these components are herein called “full card data” and allow transactions to be initiated reliably via traditional payment networks.

Also today, full card data may be delivered through short-range electro-magnetic field (EMF), using near-field communication (NFC) technology. The information that is delivered this way ultimately is the same as the information delivered using the magnetic stripe or embedded chip in a more traditional payment card.

Further, there are systems designed to deliver a replica of a card—on a mobile phone screen, a computer screen, or even printed on paper—including the PAN, expiry, and, if allowed by the card association, a secondary security code.

These existing replica systems suffer from security and usability issues that limit the ease of use and, usually, engender strict and rather harsh limits on the amount of funds that can be loaded onto and spent with the replica.

Properly handling digital presentation of full card data requires that the method(s) of request, storage and display must be secure. Further, the actual use of the full card data should be monitored in such a way that it can be established with high certainty that the full card data was revealed in a particular context, preferably even to the point of being able to establish which individual caused the payment card information to be revealed and presented.

### BRIEF DESCRIPTION OF THE DRAWINGS

FIG. 1 is a schematic illustration of an example digital card presentation according to an embodiment of the disclosure.

FIG. 2 is a schematic illustration of additional information displayed according to an embodiment of the disclosure.

FIG. 3 is a schematic illustration of a digital payment card presentation according to an embodiment of the disclosure.

FIG. 4 is a schematic illustration of a response when a screen shot is attempted according to an embodiment of the disclosure.

FIG. 5 is a schematic illustration of a digital payment card presentation according to an embodiment of the disclosure.

FIG. 6 is a schematic illustration of a digital payment card presentation on a device including a proximity sensor according to an embodiment of the disclosure.

FIG. 7 is a schematic illustration of a digital payment card presentation with an incentive according to an embodiment of the disclosure.

FIG. 8 is a schematic illustration of a system for providing a digital payment card presentation according to an embodiment of the disclosure.

### DETAILED DESCRIPTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known mobile device components, hardware, software, and processes have not been described or shown in detail in order to avoid unnecessarily obscuring the invention.

The digital card presentation described here may reduce or even eliminate many of the security concerns associated with virtual presentation of full card data, while simultaneously enhancing the usability and flexibility of the digital card.

In an example embodiment, a software application (the “mobile application”) may run on a processor and/or processing unit included in a mobile phone, contact an associated application running on a server (the “server application”) that includes a processing unit, and request card information for display. The request and delivery of the full card data may be handled in a secure manner, for example, with encryption of the full card data while in transit and with mechanisms to ensure that the full card data is revealed—e.g., presented for visual inspection, or made available for automated, machine-to-machine transfer—only when required and only for a limited period of time.

A user may select an option in the mobile application to present on-screen a representation (the “replica”) of a payment card, which may include presenting the PAN, expiration date, and/or security code. The replica may at first be shown with portions of the sensitive information obfuscated, in accordance with good security practices and/or in accordance with card association requirements. For example, of a 16-digit PAN, only the first six digits of the PAN (constituting typically the BIN, or bank identification number) and the last four digits of the PAN will be displayed in readable form; the remaining, interior, digits may be replaced with, for example, asterisks.

While full card data may be provided by the replica when authentication of identifying information has been accomplished, it may be desirable to assemble full card data at the time of or just prior to the presentation of the replica. This may be accomplished by separating the full card data into “fragmented card data”, which must be reassembled to constitute full card data.

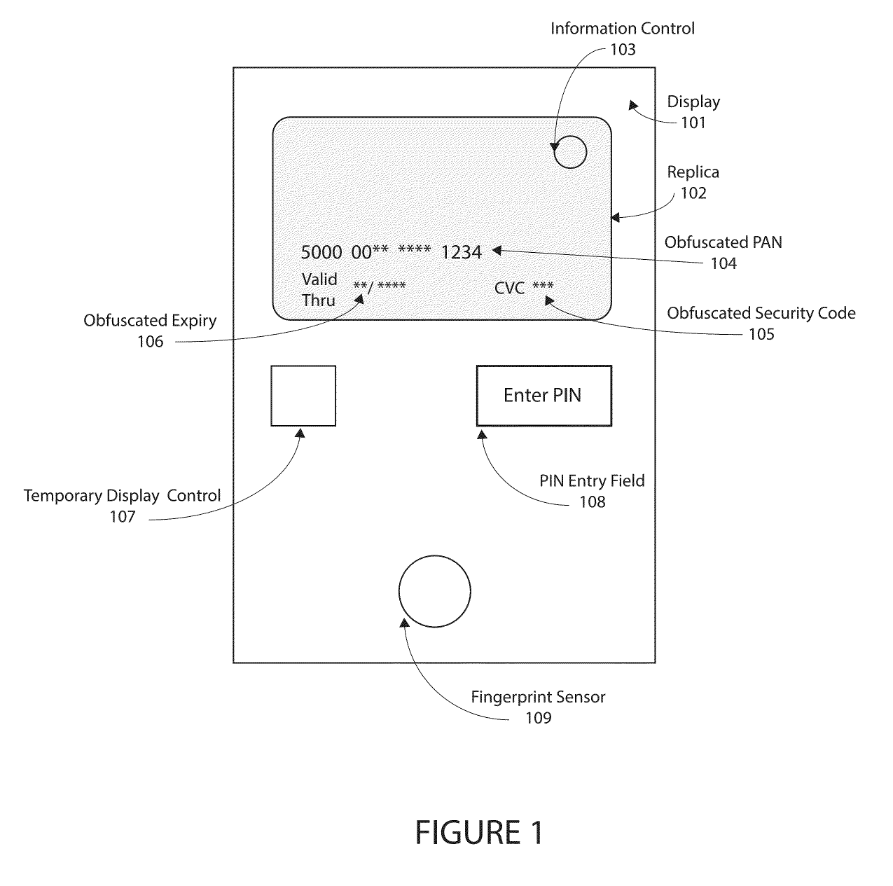

FIG. 1 is a schematic illustration of an example digital card presentation on a display 101 showing a replica 102 of a payment card along with user-facing controls that may cause the full card data to be displayed for use. When first presented to the user, the replica 102 shows the obfuscated PAN 104, the obfuscated security code 105 and the obfuscated expiry 106. Also shown in FIG. 1 is the information control 103 which allows the user to display additional information, which will be described in more detail later on. In some embodiments, the user may be first required to enter his or her PIN code in the PIN entry field 108. If the PIN code is correctly entered, the temporary-display control 107 may be highlighted and the user may then be required to touch and hold this temporary-display control to cause the full card data to be displayed. There may or may not be a defined time during which the user may cause display of the full card data after the identifying information is delivered.

It should be noted that other identifying information may be requested of the user in place of or in addition to a PIN code. As used herein, identifying information is used to mean identifying information that the user provides to demonstrate the user's identity. An example of alternative identifying information that could be provided is the user may be required to use a fingerprint sensor 109 as identification. More than one type of identifying information may be requested. For example, a user may be requested to use a PIN code plus the fingerprint sensor 109. Other combinations may be used.

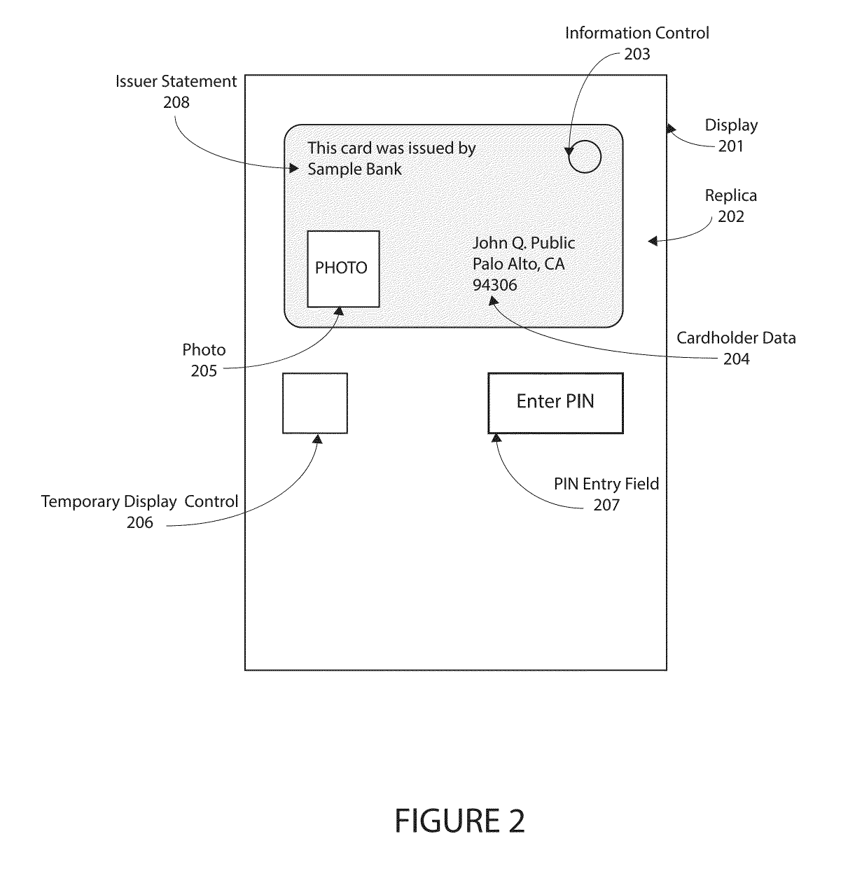

FIG. 2 shows a display 201 that provides additional information related to the digital card as presented to the user by the mobile application on the display 201 in an example embodiment. In this case, the user may have touched the information control 203 and the on-screen replica 202 may have “flipped over,” showing a representation of the reverse (back) of the digital card. The front of the digital card may appear as shown in FIG. 1 in some embodiments. Here, information related to the payment card may be displayed for the user. Information displayed may include an issuer statement, specific information about the use of the card, the security code, and any other information that is relevant to the card or the use of the card. In this example, the cardholder's personal information 204 (e.g., name and address) is shown along with the issuer statement 208 and a photograph 205.

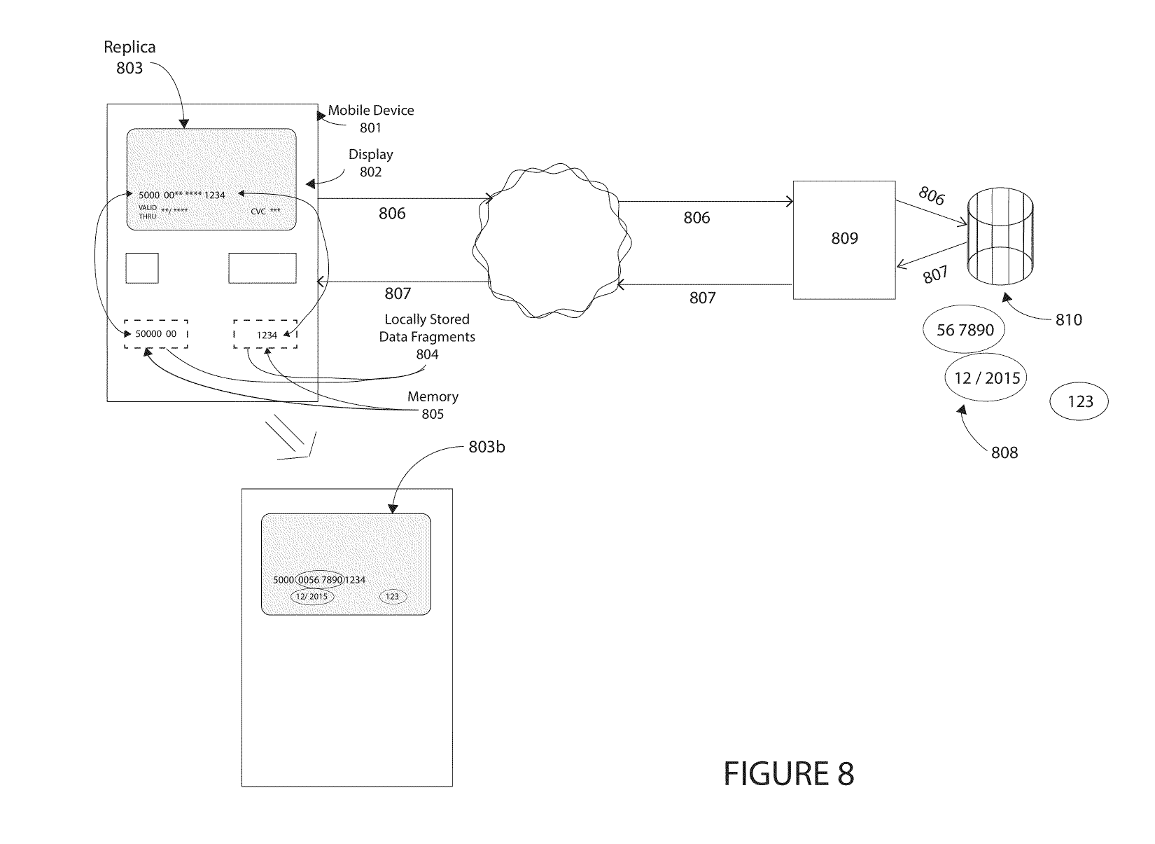

When the identifying information is successfully entered, the server application may or may not be notified. In the example embodiment, the server application may be notified by the mobile application, the notification may include the location of the user's mobile device (as determined, for example, by GPS). Further, once the identifying information has been entered correctly, in an example embodiment shown in FIG. 8, the mobile application running on a mobile device 801 may contact the server application 809 using secure network connections, such as HTTPS (HTTP over SSL—secure sockets layer) and send a request 806 that full card data or elements of fragmented card data be sent to the mobile application running on the mobile device 801. In this embodiment, some elements of the fragmented card data are stored on the mobile device 801. For example, the first six digits of the PAN (these are the bank identifier number, or BIN) and the last four digits of the PAN may be stored on the mobile device 801 as “locally-stored data fragments” 804 stored in local memory 805. The server application 809 may deliver via reply 807 the missing elements of the fragmented card data (“remotely-stored data fragments” 808 stored in a memory 810 accessible to the server application 809). For example, the remotely-stored data fragments 808 may include of the missing portion of the PAN, the expiry and the security code, in which case the mobile application may assemble the remotely-stored data fragments together with the locally-stored data fragments to yield the full card data for display via the replica 803 on a display 802 of the mobile device 801. The replica 803 with the full card data is shown below as replica 803B. The remotely-stored data fragments 808 added to the locally-stored data fragments 804 are indicated by circles in replica 803B. Assembling these pieces of the full card data just prior to display may increase security since the full card data is not held in one place for any length of time. As an alternative, the server application may deliver the full card data. In an alternative embodiment, the remotely-stored data fragments may be stored locally in local memory 805 or another memory in the mobile device 801. The fragmented card data and/or the full card data may be stored in encrypted form and decrypted just prior to display.

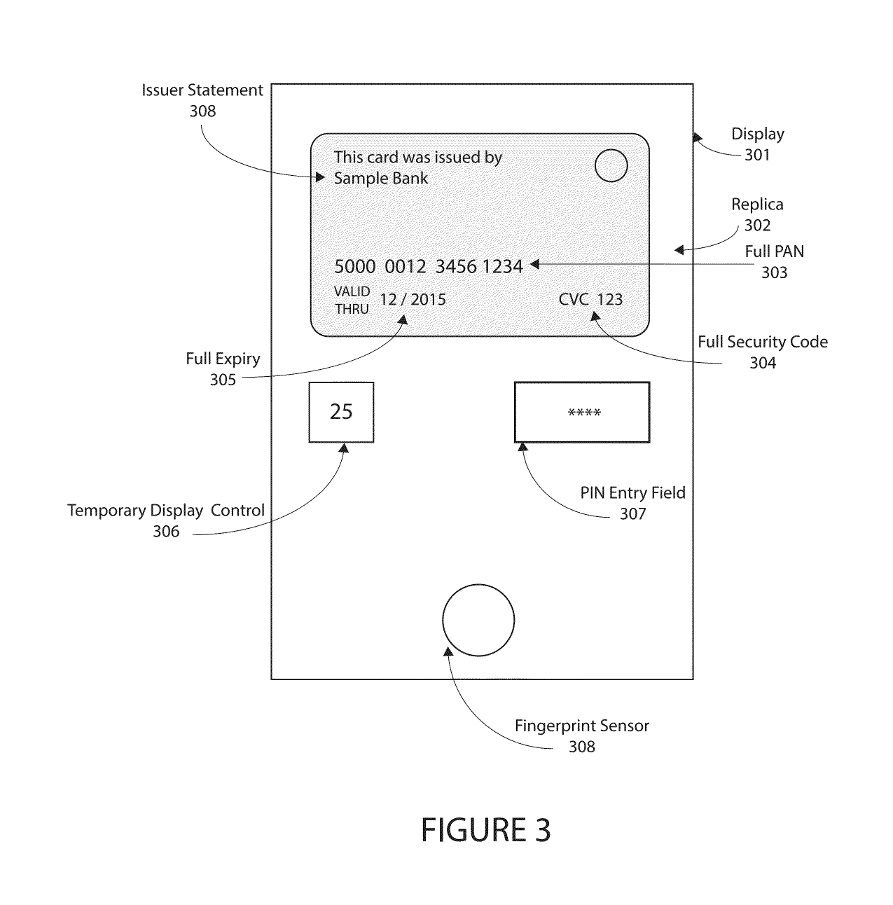

FIG. 3 is a schematic illustration of a digital payment card presentation according to an embodiment of the disclosure. When the user has been authenticated by, for example, correctly entering his or her PIN in the PIN entry field 307 and/or by presenting a fingerprint via the fingerprint sensor 308, the mobile application may, as shown in FIG. 3, present the replica 302 on the display 301, with all PAN digits 303, full expiry 305 and full security code 304. This full card data may be revealed for a specific period of time, or it may be revealed for the time interval between the user first touching the temporary-display control 306 and the user again touching the temporary-display control 306, or it may be revealed for as long as the user continues to press on the temporary-display control 306. Combinations of these conditions may also be used. Once the conditions for clear display are no longer met, (e.g.—the user stops pressing the temporary-display control, if continuous pressing is required), the display may return to an obfuscated form. It may be the original obfuscated form, for example, as shown in FIG. 1, or a different form, but it may no longer display the full card data in entirety; at most, only portions of the full card data may be presented.

Characteristics of such a system may include a) the full card data may be in its vulnerable, clear form for a restricted period of time; b) a user requirement, such as constant pressing on the temporary-display control, may make capturing a screen shot much more difficult.

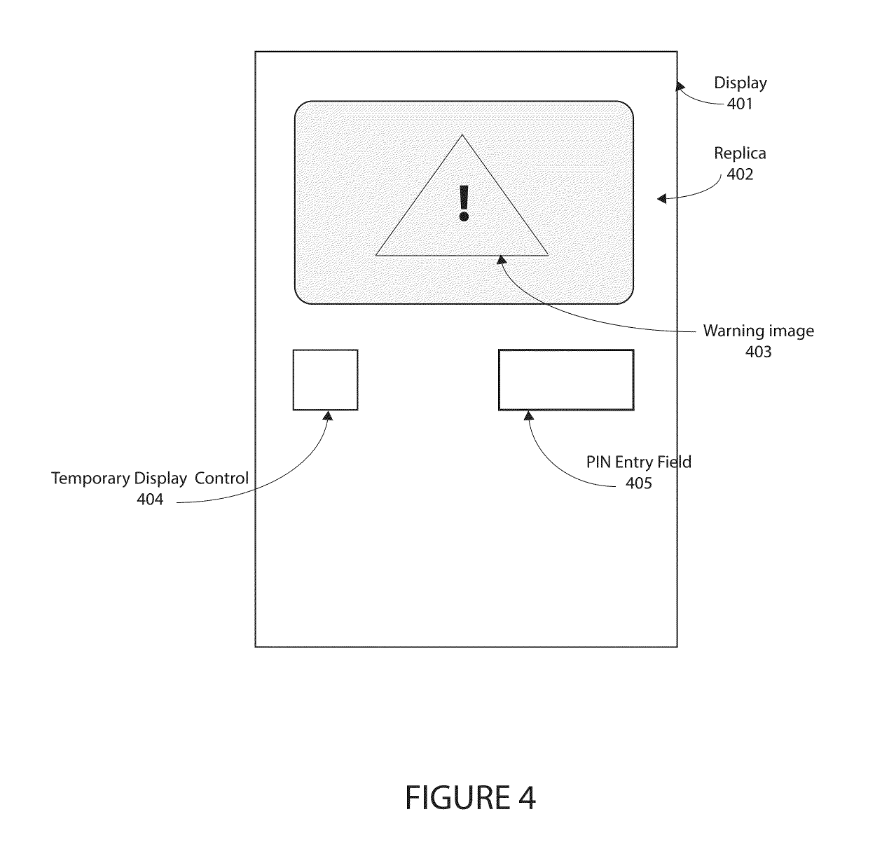

FIG. 4 shows a response of the mobile application in an example embodiment when the user has attempted to capture a screen shot. The mobile application may present via the display 401 the replica 402 with full card data removed. A warning image 403 may indicate to the user that the activity is forbidden.

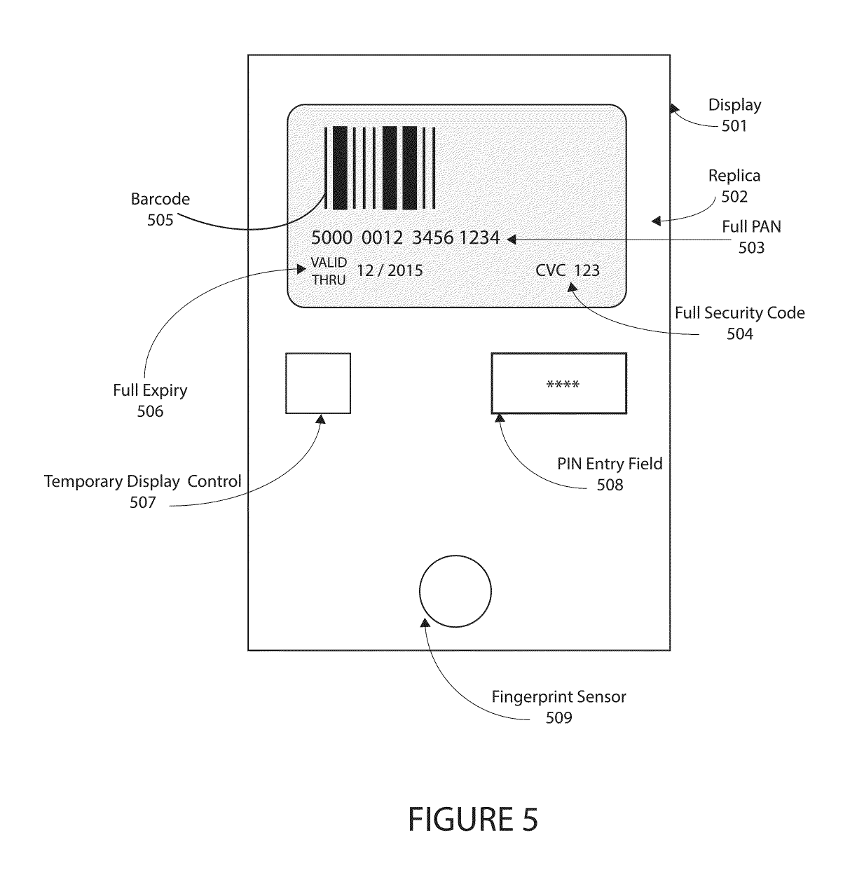

Another embodiment of such a system may present the full card data not as human-readable characters, or not solely as human-readable characters, but would instead, or in addition to, present some or all of the full card data as a barcode or other encoded display, readable by a scanning device. FIG. 5 shows such an embodiment. The mobile application shows the replica 502 on the display 501. The user may have authenticated via the PIN entry field 508 or the fingerprint sensor 509, so the full card data is now displayed. The full PAN 503, the full security code 504 and the full expiry 506 are displayed for the user. Further, a barcode 505 representing some or all of this full card data in machine-readable format is displayed as well.

Other presentation channels may also be used including, but not limited to, near field communication (NFC), audio, infrared, and Bluetooth/WiFi. In each case, some subset of the full card data may be made available prior to the user entering identifying information, with full card data being made available after the entry of this identifying information.

The context of the user or another associated party may be used to influence the presentation of the replica. For example, the system may require that a user be within a specific geographic region in order to display the full card data, regardless of whether the user has correctly provided identifying information. The user's geolocation may be used to influence whether the query for full card data or fragmented card data may even be made; if that query is made, whether the full card data may be displayed; if the full card data is displayed, how that full card data is displayed.

Further variations are possible: the context of the user (for example, the time of day or geolocation) may be used to determine whether the identifying information may even be entered or not. Context may also be used to determine which identifying information is required. For example, one PIN code may be required when the user is at home, accessing the replica via mobile phone, and a different PIN code may be required when the user is away from home accessing the replica by mobile phone. The characteristics of the device being used to access the replica may be used to determine (solely, or in combination with context) which identifying information will be accepted—and how that may be accepted. As an example, at home a PIN code may be required when accessing the replica by mobile phone, while away from home a fingerprint read may be required for access by mobile phone, with only a PIN required to access the replica by laptop computer.

“Context” may include factors such as geolocation, location (as in being located at an intersection of two streets), time of day, proximity to a beacon, proximity to another device (e.g.—in or near an automobile, or close to an NFC chip), proximity to the user. This context may be obtained through the use of sensors on the mobile device, such as GPS sensors for geolocation or a proximity sensor to detect whether a mobile phone is being held up to the user's head or face.

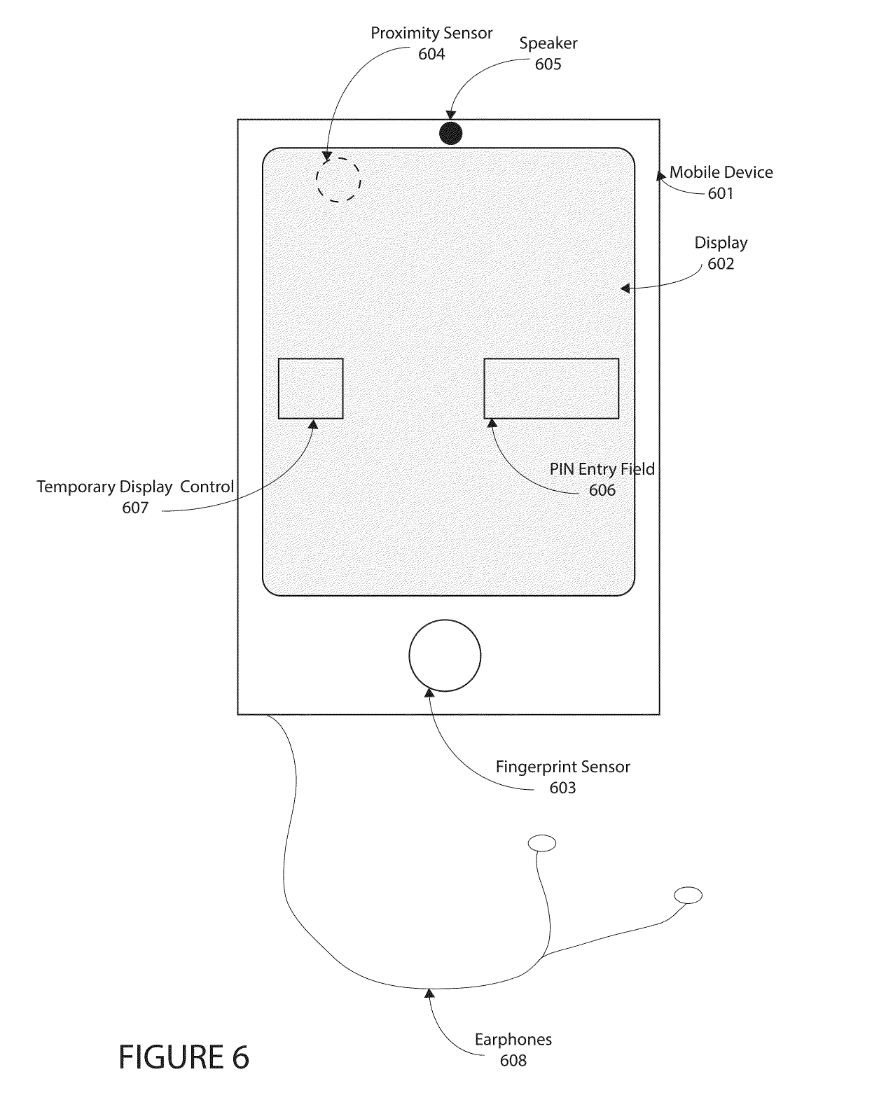

An additional example embodiment includes the mobile application utilizing a proximity sensor on a mobile phone to determine whether the phone is being held up to the user's face. In this example, shown in FIG. 6, the role of the temporary-display control 607 may be played by the proximity sensor 604; once the user has entered the required identifying information (for example, via the fingerprint sensor 603), the user may then hold the device 601 up to his or her ear. The mobile application may detect this change based on information received from the proximity sensor 604 and then present the replica—the full card data—in the form of ‘spoken’ digits, for the user to hear, via a speaker 605. This speech stream may be delivered once, or may repeat and then cease when the handset is lowered. A variant of this utilizes the identifying information to allow delivery of the full card data, again with the delivery being by ‘spoken’ digits and information, but with no proximity requirement. Thus, the user could authenticate, then touch the temporary display control 607 and listen through earphones 608 as the full card data is spoken, leaving the user's hands free to type.

User authentication may be accomplished through the addition of delivery of a one-time code, via SMS or other push notification such as email. Delivery of this code may be triggered by specific user request, or by an action that is part of the sequence of displaying or preparing to display the replica. For example, the user entering his or her identifying information may trigger delivery of a one-time code, which would be required in addition to the identifying information in order to release the display of the replica.

A further variant of this incorporates a designated third party who must be consulted in some fashion for release of the replica. For example, the third party may have to agree to allow the replica to be displayed. Or, the third party may be required to create and enter a code, and then separately deliver the code to the user. The user then has to enter this code as part of the sequence to allow display of the replica.

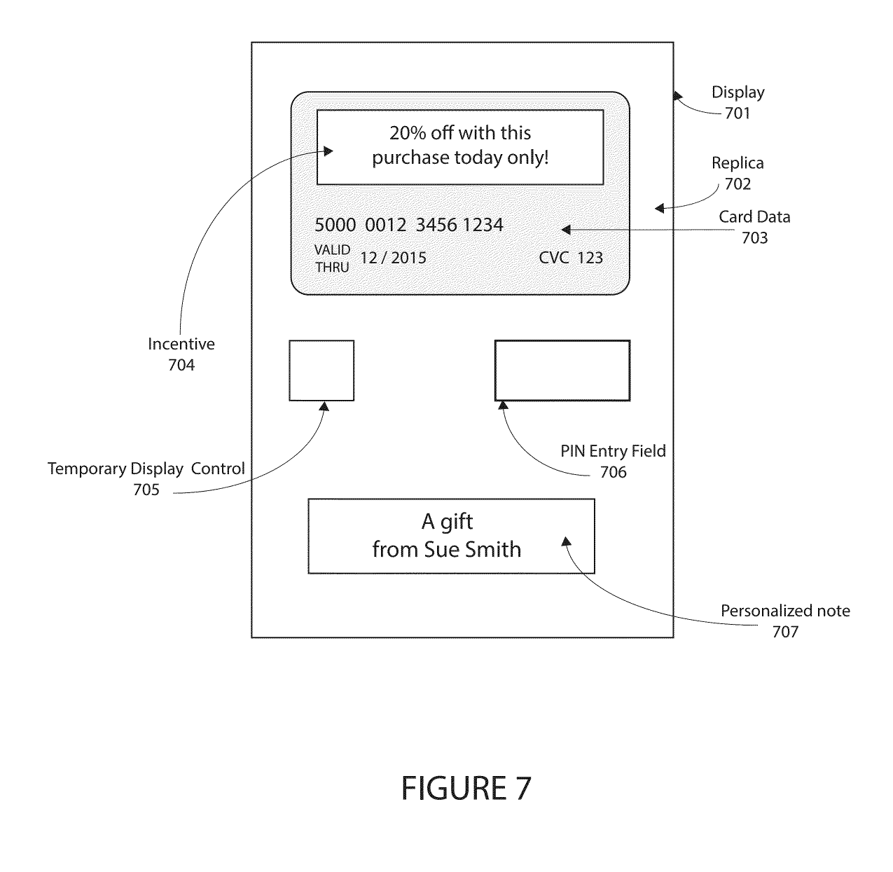

It may be desirable for the use of a replica to be combined or correlated with other actions, such as presentation of incentives or personalized notes. In an example embodiment as shown in FIG. 7, a replica 702 may be presented on a display 701 on a mobile device. When the full card data 703 is revealed, the user may also be presented with an incentive 704 that maybe applied to the purchase. Or, an incentive may be presented prior to or after the display of the full replica.

A further variant on this example sees the replica enhanced with a personalized note 707—for example, in the form of a text comment from a friend who has given the user funds, or has even given the user the ‘card’ underlying the replica. The personalized message may instead be an image, a video, an audio recording, or any combination of these. The message is presented in the flow of utilizing the replica—before the replica is fully revealed, while it is revealed, or after it is no longer revealed. The message may also change states, depending on the context of the user or depending on the existence of or the outcome of the requested transaction. Further, if the replica is a replica of a card that has rules associated with it, such as a card that may be locked and unlocked, the incentive or personalized message may be presented in response to the lock or unlock activity.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus, comprising:
an input device configured to receive identifying information from a user;
a memory configured to store data corresponding to a payment card;
at least one processing unit configured to analyze the identifying information received by the input device and determine if the identifying information is valid; and
an output device configured to:
access the memory and provide a portion of the data corresponding to the payment card to the user;
access the memory and provide the data corresponding to the payment card to the user, responsive to the at least one processing unit determining validity of the identifying information.

2. The apparatus of claim 1, wherein the input device is a fingerprint sensor.

3. The apparatus of claim 1, wherein the output device is an electronic display.

4. The apparatus of claim 1, wherein the output device is an audio speaker.

5. The apparatus of claim 1, wherein the output device is further configured to provide the data corresponding to the payment card to the user only when the user maintains physical contact with the input device.

6. The apparatus of claim 1, wherein the output device is further configured to provide the data corresponding to the payment card to the user for a period of time.

7. The apparatus of claim 1, further comprising a geolocation device configured to determine a location of the user, and wherein the output device is further configured to provide the data corresponding to the payment card to the user only when the geolocation device determines the location of the user is within a certain geographic region.

8. A method, comprising:
providing partial payment card information to a user
receiving identifying information from the user;
determining, with a processor, validity the identifying information; and
providing full payment card information to a user, responsive to determining validity of the identifying information.

9. The method of claim 8, further comprising:
requesting the full payment card information from a remote server responsive to determining validity of the identifying information.

10. The method of claim 8, wherein the identifying information is at least one of a fingerprint, a PIN, and a password.

11. The method of claim 8, wherein the full payment card information is at least one of a PAN, an expiration date, and a security code.

12. A system, comprising:
a memory storing data, wherein the data includes at least one of a payment card PAN, expiry and card security code;
an input mechanism configured to allow input of identifying information by a user;
a processor coupled to the input mechanism and the memory, wherein the processor is configured to access the data in response to the user supplying identifying information;
the processor further configured to:
manipulate the data for presentation;
generate a replica that includes the data; and
a display configured to provide the replica to the user.

13. The system of claim 12, wherein fragments of the data are stored in the memory and other fragments of the data are stored on a server in a remote memory, wherein the processor is further configured to generate a request via a network to the server to obtain the other fragments of the data and assemble the fragments of the data stored in the memory together with the other fragments of data received from the server to generate the data.

14. The system of claim 12, where portions of the data in the replica are obfuscated prior to the processor receiving valid identifying information from a user, and where the data in the replica are not obfuscated after the processor has validated the identifying information.

15. The system of claim 12, wherein portions of the data in the replica are obfuscated until the processor receives valid identifying information from the user and until the user activates a temporary display control included in the input mechanism.

16. The system of claim 15, wherein the temporary display control is a virtual control on the display.

17. The system of claim 15, wherein the temporary display control is a proximity sensor.

18. The system of claim 12, wherein the processor is further configured to detect an attempt to capture a screen shot of the display and is configured to remove the data from the replica on the display when the attempt is detected.

19. The system of claim 12, wherein the processor is further configured to receive the user's geographical location and to allow or disallow presentation of the replica based on the user's geographical location.

20. The system of claim 12, wherein the processor is further configured to receive the user's geographical location and to adjust the allowed method of input of identifying information based on the user's geographical location.
